(19) United States
(12) Patent Application Publication
(10) Pub. No.: US 2023/0258212 A1
(43) Pub. Date: Aug. 17, 2023

(54) FASTENING SYSTEM

(71) Applicant: GOTTLIEB BINDER GMBH & CO. KG, Holzgerligen (DE)

(72) Inventors: Konstantinos POULAKIS, Hildrizhausen (DE); Lars HEEPE, Tübingen (DE)

(21) Appl. No.: 18/014,202

(22) PCT Filed: Jun. 22, 2021
(86) PCT No.: PCT/EP2021/066914

§ 371 Date: Jan. 3, 2023

(30) Foreign Application Priority Data
Jul. 23, 2020 (DE) 10 2020 004 438.7

(51) Int. Cl. F16B 11/00; F16B 5/00

(52) U.S. Cl. CPC F16B 11/006; F16B 5/0004

(57) ABSTRACT

A fastening system is disclosed, which can be applied repeatedly to third components, preferably having a smooth surface, for the purpose of detachable fastening to the same, consisting of at least two interconnected functional parts (2, 6) of planar shape, of which at least one functional part (2) has the form of a film and bears information and at least one further functional part (6) has a plurality of individual elements (4), the free end faces (8) of which adhere to the surface of the respective third component by means of adhesion.

The invention relates to a fastening system.

Fastening systems of various types and for a wide range of applications are known from the prior art. There are fastening systems that can be cyclically attached in a re-detachable manner to third components by means of glues, such as, for instance, pressure-sensitive acrylic adhesives (EP 0 429 269 B1). Adhesive fastening systems of this kind have the disadvantage that they regularly cannot be removed from the third component without leaving residues and that only a small number of fastening cycles can be achieved.

To avoid these disadvantages, further fastening systems (DE 10 2012 013 124 A1) have been developed in the past for the full-contact covering of third components, without residue and damage, such as traffic signs, wherein magnets, attached to a back of the third component, attach simple cover elements made of sheet iron to this third component. Furthermore, there are solutions in the prior art for directly attaching magnetic films to a metallic third component in a re-detachable manner. The disadvantage of these solutions is that an additional magnet is required to attach preferably non-metallic third components, such as those made of plastic, or that the magnetic film is a remedy, which cannot be attached to non-magnetic surfaces.

Furthermore, there are solutions in the prior art in the form of a covering adhesive film system (DE 10 2016 108 328 B3) that uses silicone as the adhesive coating agent, wherein this self-adhesive system on third components always proves to be disadvantageous if the surfaces to be joined are contaminated with particles, if there is a rather high ambient humidity or if the surface to which the self-adhesive fastening system is to be applied is very rough.

The known fastening solutions described above have been used to attach decorative and informative markings to aircrafts, motor vehicles and rail vehicles (EP 0 429 269 B1) or to visibly cross out information content of traffic signs, such as road signs that are no longer valid (DE 10 2012 013 124 A1).

Based on this prior art, the invention addresses the problem of creating a fastening system that contributes to avoiding the disadvantages mentioned above. A fastening system having the features of claim 1 solves this problem.

The fastening system according to the invention is characterized in that it can be applied several times, even in immediate succession, to third components having a preferably smooth surface for the purpose of the detachable attachment to the latter and in that it consists of at least two interconnected functional parts of planar shape, of which at least one functional part has the form of a film and bears information and at least one further functional part has a plurality of individual elements, the free end faces of which adhere to the surface of the respective third component by means of adhesion.

As shown in the prior art, the one film-like information-bearing functional part can be applied in a decorative manner and provided with markings to airplanes, motor vehicles and rail vehicles or can serve to temporarily cover at least parts of traffic signs to cross out their information content that is no longer applicable or to render it unrecognizable.

The second further functional part together with its plurality of individual elements achieves adhesion of the fastening system to any surfaces of the third component; in particular, the fastening system adheres well even to moist, dirty and relatively rough surfaces owing to the adhesive effect, wherein adhesion occurs without leaving any residue (even on those surfaces having non-magnetic properties).

In a preferred exemplary embodiment, provision is made that a connecting means, in particular in the form of a glue, is introduced between the two functional parts for keeping them together. Preferably, for this a glue is used that is related to at least one of the two functional parts, for instance a silicone glue, provided that the one functional part having the plurality of individual elements is made of a polyvinylsiloxane material.

In a further preferred exemplary embodiment, provision is made that, for a sandwich-like structure between the two functional parts a third functional part is arranged, which, designed as a support part, has the connecting means to at least one of the adjacent functional parts on at least one of its two sides, preferably on both sides. Preferably, the third functional part is designed in the form of a profile supporting layer, which can be used to adapt the fastening system to the required stiffness, in particular to increase the bending stiffness of the fastening system.

In a further preferred exemplary embodiment, provision is made that all functional parts, including any connecting means, are provided as layers and, at least in an initial state prior to use, are in contact with one another in a plane-parallel and full-contact manner and without any protrusions. The usual film manufacturing processes can be used because of the plane-parallel, protrusion-free layering in a particularly advantageous way to obtain a functionally reliable fastening system at low cost.

In another preferred exemplary embodiment, provision is made that at least some of the functional elements themselves have a multilayer structure, in this way, a functional element can be designed having layers providing functions differing from each other, which conjointly result in the desired overall function of the respective functional element.

In a further preferred exemplary embodiment, provision is made that the further functional part as a whole together with the individual elements is subdivided into groups, which, at least in a longitudinal and/or transverse direction to the extension of the film of the one functional part, have a predeterminable distance from one another, which preferably has a gap size that is preferably smaller than the film thickness of each of the functional parts. Preferably, provision is made that a group member of the groups is formed of a single segment which, in conjunction with further segments, forms the further functional part as a whole. The additional functional part, which is preferably produced in a so-called chill-roll process as a microreplication process, having the plurality of individual elements can only be available, in a certain maximum width, for instance 100 mm, owing to the manufacturing process, so that several of the one type of functional parts can then be applied in a side-by-side arrangement in the transverse direction to the film run. Because the aforementioned films, forming the further functional part, also only have a certain manufacturing length, gaps also occur in the longitudinal direction to the longitudinally oriented course of the film of the one functional part.

The segments, applied in groups to the one functional part, then form in conjunction with the further groups of segments the further functional part as a whole.

In a further preferred exemplary embodiment, provision is made that the functional parts arranged adjacent to one another, are connected to each other without glue by means of a coating or lamination process.

The individual functional parts, consisting of plastic materials, still have a certain amount of residual heat due to their manufacturing process and are therefore not yet fully cross-linked. A conventional roller stand can then be used to set such a high contact pressure that the film-like functional parts are intrinsically connected to one another, forming a product in this way. However, it is also possible to introduce a film-like acrylate adhesive layer between the functional parts quasi in-situ again using the reaction heat to connect the films, resulting in an improved, long-lasting glue-based connection.

In another preferred exemplary embodiment, provision is made that the respective functional part consists of a plastic material, such as polyethylene material, and that the further functional part, at least to the extent of its individual elements, has adhesion properties of a polyvinylsiloxane material. Overall, however, materials from the class of poly(organo)siloxanes can be used for this purpose. Preferably, the entire further functional part with its individual elements is formed from a polyvinylsiloxane material whose adhesion property results in an improved adhesion of the fastening system to third components, having in particular an improved adhesion coefficient, increased peel strength values and shear strength values.

Provision is made in a further preferred exemplary embodiment that the one functional part is designed in color and bearing information, with symbols including text are printed thereon, reflective, fluorescent, luminous, matte, glossy or provided with AI. Due to this the one functional part can be used to transmit information including warning notices to persons viewing the fastening system. Whenever AI (artificial intelligence) is mentioned in this context, it refers to intelligent systems such as transponders, computer chips, digital displays, etc.

In another preferred exemplary embodiment, provision is made that at least one of the functional parts is equipped with additional functions, such as being flame retardant, recyclable, biodegradable, incinerable, magnetizable or exhibiting magnetic properties, being resistant to electrostatic charge or being electromagnetically compatible (EMC), and being abrasion resistant. In this way, the basic function of the respective functional part can be expanded in a modular fashion.

In a further preferred exemplary embodiment, provision is made that the further functional part having the individual elements, capable of adhesion, can be produced using a forming screen in a chill-roll process. As a result, the further functional part having the individual elements, capable of adhesion, can be produced on an industrial scale by means of a microreplication process, and the extrusion product produced in this way can be continuously manufactured with the other functional parts of the fastening system in film design as part of coating or lamination processes, wherein this process can be largely automated.

In a further preferred exemplary embodiment, provision is made that the fastening system can be designed as rolled or wound material, in the unrolled or unwound state and divided into predeterminable lengths can fulfill the respective purposes. This means that the fastening system can be transported and stored in a particularly space-saving manner.

The subject matter of the invention is also a tradable merchandise item consisting of a plurality of such fastening systems, which, combined on a carrier strip, as small parts that can be separated from one another, after they have been detached from the carrier strip, are provided for the application for detachable adhesion to the third component. Particularly in the context of construction site applications, the fastening systems, variously assembled in this way, can be made available on site.

A further subject matter of the invention is also the use of a fastening system to this effect, wherein said fastening system is used to render the information content of traffic signs of any kind ineffective and/or is used as a warning to make vehicles, such as construction vehicles, recognizable, and wherein by detaching the fastening system from such third components, the ineffective-rendering or the making-recognizable is removed without leaving any residue. As a result, the fastening system can be applied with a high degree of repeatability to dirty, rough, moist and/or non-magnetic traffic signs or vehicles without leaving any residue on this respective third component.

Below, a fastening system according to the invention will be explained in more detail with reference to the drawing. In the figures, in a representation in principle and not to scale,

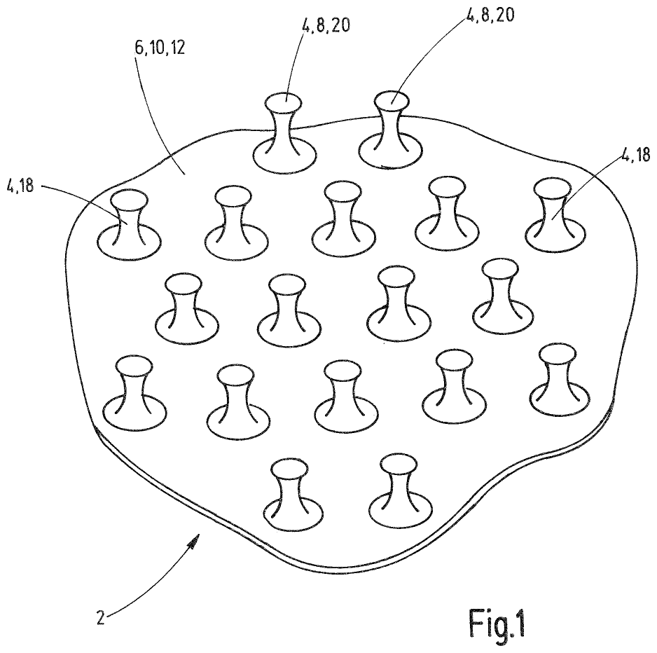

FIG. 1 shows a perspective top view of a part of the fastening system having individual elements projecting upwards, as part of a adhesion film forming the further adherent functional part, which is arranged on the subjacent film forming the one information-bearing functional part;

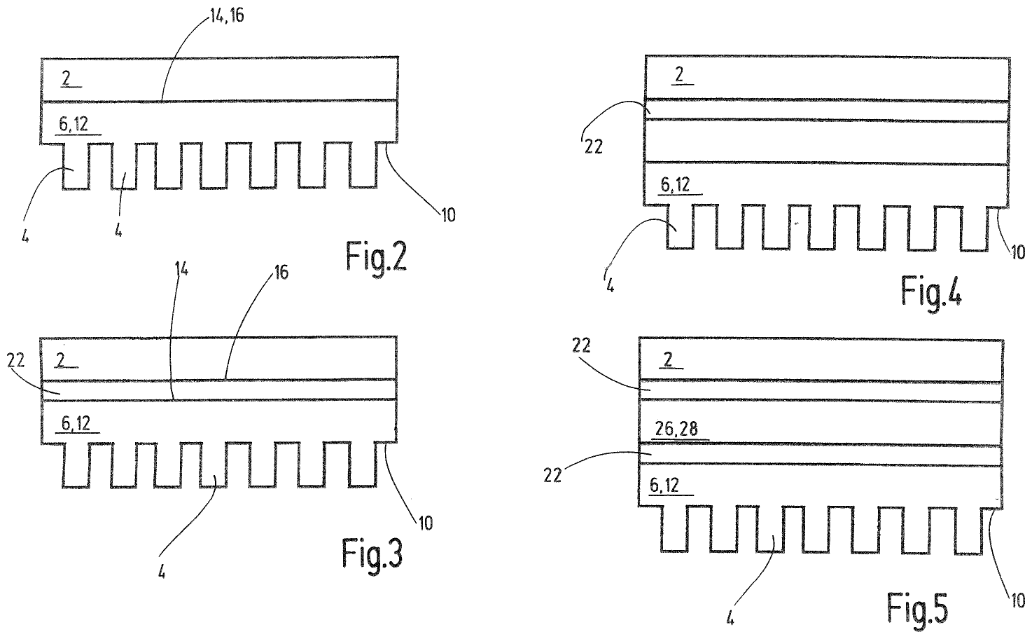

FIG. 2 shows a side view of a fastening system according to the invention, consisting of the one functional part and of the further functional part according to the representation in FIG. 1;

FIG. 3 shows a side view of the fastening system of FIG. 2, wherein a connecting means is provided between the two functional parts;

FIG. 4 shows a side view of the fastening system of FIG. 3, wherein a third functional part in the form of a support part is provided between the one functional part and the further functional part, wherein a connecting means is introduced between the latter and the one functional part;

FIG. 5 shows a side view of the fastening system of FIG. 4, wherein between the one functional part and the support part as well as between the support part and the further functional part a connecting means is provided each;

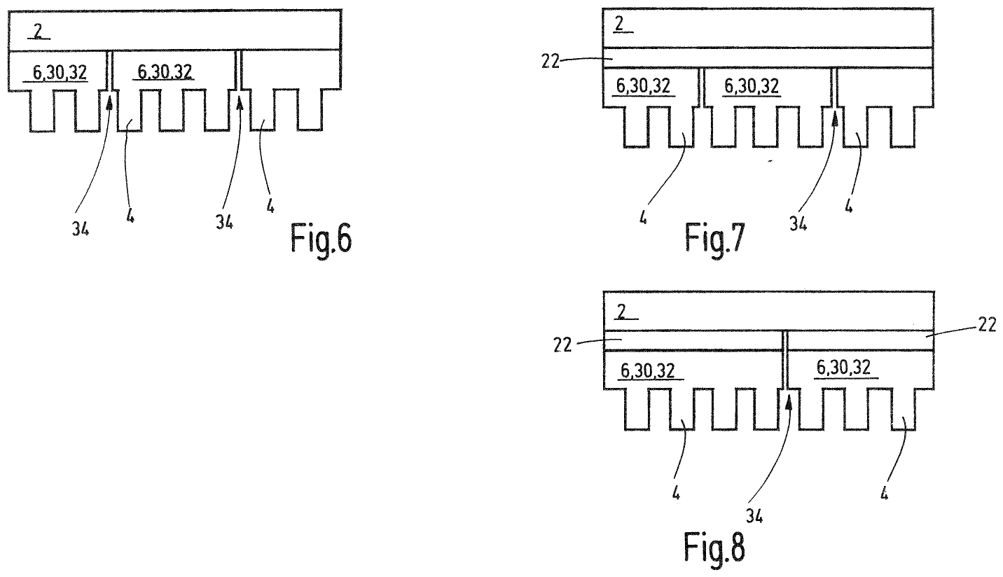

FIG. 6 shows a side view of the fastening system shown in FIG. 2, wherein the further functional part is shown subdivided into segments each belonging to a group;

FIG. 7 shows a side view of the fastening system of FIG. 3, wherein the further functional part according to FIG. 6 is shown subdivided into segments;

FIG. 8 shows a side view of the fastening system of FIG. 7, wherein in addition to the further functional part the connecting means is subdivided corresponding to the segments of the further functional part; and

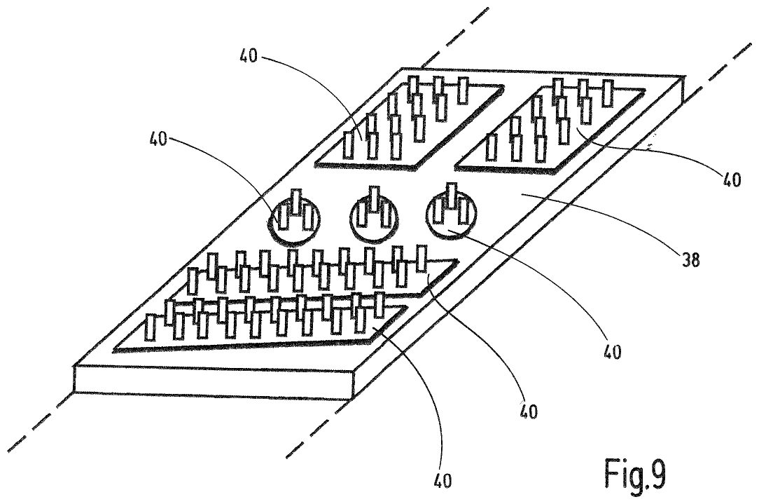

FIG. 9 shows a perspective oblique view of a marketable goods unit having several fastening systems according to the invention from FIGS. 1 to 8.

The figures show a fastening system for a repeated, re-detachable attachment to third components having a preferably smooth surface (not shown). The fastening system has at least two interconnected functional parts 2, 6 having a planar extension, i.e., at least one information-bearing first functional part 2 formed as a film, and at least one second, further functional part 6 comprising a plurality of individual elements 4. The free end faces 8 of the individual elements 4 adhere to the surface of the respective third component, for instance the surface of a traffic sign or a motor vehicle, by means of adhesion.

FIG. 1 shows the individual elements 4 extending largely at a right angle away from a first free and flat lateral surface 10 of a base part 12 of the further functional part 6. At its second flat lateral surface 14 opposite from the first lateral surface 10, the further functional part 6 is firmly connected to a first flat lateral surface 16 of the one functional part 2.

The individual elements 4 are each formed from stem or stalk parts 18, the free ends 8 of which widen in diameter in the form of a broadening 20. The individual elements 4 are furthermore set up in such a way that the adhesion of the broadenings 20 to a third component is implemented mainly by means of Van der Waals forces.

The further functional part 6 formed in this way can be manufactured very inexpensively on a large industrial scale and be connected to the surface of any third component and repeatedly reattached because the broadenings 20 of the individual elements 4 interact directly with the surface of the third component via the Van der Waals forces.

Because the Van der Waals forces are only effective over a short range, all the individual elements 4 preferably have the same length or height, so that the free ends 8 of the individual elements 4 are arranged in one plane. The individual elements 4 have sufficient inherent rigidity to prevent the individual elements 4 from buckling away from the surface, to be contacted, of the third component.

To ensure sufficiently good detachment behavior, the broadenings 20 of the individual elements 4 can each be connected to the stem part 18 via a corresponding reduction in diameter in the transition area to the stem part 18, forming a kind of joint at the transition point. In this way, when the fastening system is detached from a third component, the base part 12 of the further functional part 6 can be peeled off together with the stem parts 18 and the still adherent broadening 20 of the individual elements 4 can follow the peeling motion in the way of a rolling motion via the respective joint.

Very good adhesion results have been obtained when there are about 16,000 individual elements 4 or more per square centimeter of material of the base part 12, wherein the individual elements 4 have a length of about 100 μm or less in combination with a diameter of the head-end broadening 20 at a width of about 60 μm or less.

FIG. 2 shows a schematic, principle view of the combination of the single one functional part 2 and the single further functional part 6, which are firmly connected without any connecting means.

A connecting means 22 can be inserted between two adjacent functional parts 2, 6 for firmly holding together or firmly interconnecting the two functional parts 2, 6. Thus, in FIG. 3, such a bonding layer 22 is introduced between the first lateral surface 16 of the single one functional part 2 and the second lateral surface 14 of the single further functional part 6, in particular in the form of a glue suitable for this purpose.

In FIG. 4, in the manner of a sandwich-like structure a third functional part 26 in the form of a support part 28 is arranged between these two functional parts 2, 6, wherein said support part is firmly connected to the further functional part 6 without any connecting means. In addition, a connecting means 22 is provided between the one support part 28 and the one functional part 2. In FIG. 5, just as in FIG. 4, one connecting means 22 each is provided between the third functional part 26, which is formed as a support part 28, and the one functional part 2 as well as in addition between the support part 28 and the further functional part 6. The support part 28 may be referred to as the profile supporting layer. The respective connecting means 22 may be formed from a layer of glue, for instance using an acrylic adhesive.

FIG. 6 shows the combination of the single one functional part 2 and the single further functional part 6. The further functional part 6, including its individual elements 4 as a whole, is divided into groups 30 at least in the longitudinal direction of the fastening system. Every group 30 has at least one individual segment 32, which each is, at least in the longitudinal direction of the fastening system, located at a predeterminable distance 34 from the adjacent segment 32 of a further group 30, wherein said distance is smaller than the film thickness of each of the functional parts 2, 6. The fastening system of FIG. 7 differs from the fastening system of FIG. 6 only in that a continuous layer of the connecting means 22 is provided between the two functional parts 2, 6, whereas in FIG. 8, in addition to the further functional part 6, the connecting means or glue means is subdivided in accordance with the segments 32 of the further functional part 6, forming the predeterminable distance 34.

All functional parts 2, 6, 26, 28 and connecting means 22 are formed in layers, wherein every functional part 2, 61 26, 28 may have a multilayer structure not shown in the figures. At least in an initial state before the fastening system is applied for the first time, all layers of the fastening system are in contact with each other in a plane-parallel, full-surface and protrusion-free manner.

The further functional part 6 is formed of a polyvinylsiloxane material at least in the extent of its individual elements 4 having adhesion properties.

The one functional part 2 is at least partially made of a plastic material, such as for instance polyethylene material, and can be formed in color and bearing information, printed with symbols including text, reflective, fluorescent, luminous and/or matte or glossy. It is also conceivable that a man-machine interface, a display, for instance a digital display, a sensor, a data interface and/or a transponder interface, are integrated into the one functional part 2, each of which is connected for data processing to a computing unit on which self-learning algorithms in terms of machine learning can be implemented. In this context, a functional part 2, 6, 26, 28 designed in this way is referred to as being provided with artificial intelligence.

Every functional part 2, 6, 26, 28 may have at least one additional property: for instance, it may be designed to be flame retardant, recyclable, biodegradable, incinerable, magnetizable or magnetic, resistant to electrostatic charging or electromagnetically compatible, and/or abrasion resistant.

A fastening system designed in this way can be used to render the information content of traffic signs of any kind ineffective and/or be used as a warning sign to identify vehicles, such as construction vehicles, wherein the ineffectiveness or identification is removed without leaving any residue after the fastening system has been detached from these third components. Because of that the fastening system can be applied adherent with a high degree of repeatability even to dirty, rough, moist and/or non-magnetic third components in the form of traffic signs or vehicles without leaving any residue on the respective third components.

FIG. 9 shows a carrier strip 38, on which several fastening systems as small parts 40, separatable from one another, so-called patches 40 are detachably arranged, by means of a commercially available glue, which can be detached from the carrier strip 38 and repeatedly detachable attached to a third component. It is also conceivable that, for transport purposes or for storage, the fastening system is formed as rolled material or wound material which, in the unrolled or unwound state and in predeterminable lengths, can be separated, for instance by means of cutting, and can be repeatedly detachable attached to third components.

The manufacturing process of such a fastening system is explained in more detail below:

First of all, the further functional part 6 is manufactured by means of a so-called chill-roll process not shown in the figures. In this process, a plastic is fed to a shaping zone, formed as a conveying gap, which is formed between a pressure tool in the form of a pressure roller and a shaping tool in the form of a molding roller. The molding tool has a forming screen on its circumference, in which mold cavities are regularly distributed along its outer circumference. Viewed in longitudinal section (perpendicular to the axis of rotation of the respective roll), the mold cavities have two opposing boundary walls, preferably each having a continuously convex path. The spacing of the boundary walls widens starting from the outer circumference of the forming screen in the direction of the axis of rotation of the forming tool. When the two rolls are driven in opposite directions of rotation, they convey the plastic through the conveying gap, wherein the base part 12 or support part of the further functional part 6 is formed and the individual elements 4 are formed on the side, contacting the molding roller, of the base part 12 by means of the forming cavities of the molding roller.

Subsequently, the further adhering functional part 6 is firmly connected to the one information-bearing functional part 2 according to FIGS. 1 to 8, if required layered with the interposition of the support part 28 and/or the connecting means 22 or without a connecting means, by means of a coating or lamination process, thereby forming the relevant fastening system shown in FIGS. 1 to 8.

1. A fastening system which can be applied repeatedly to third components, preferably having a smooth surface, for the purpose of detachable fastening to the same, consisting of at least two interconnected functional parts (2, 6) of planar shape, of which at least one functional part (2) has the form of a film and bears information and at least one further functional part (6) has a plurality of individual elements (4), the free end faces of which (8) adhere to the surface of the respective third component by means of adhesion.

2. The fastening system according to claim 1, characterized in that a connecting means (22), in particular in the form of a glue, is introduced between the two functional parts (2, 6) for keeping them together.

3. The fastening system according to claim 1, characterized in that for a sandwich-like structure between the two functional parts (2, 6) a third functional part (26) is arranged, which, designed as a support part (28), has the connecting layer (22) to at least one of the adjacent functional parts (2, 6) on at least one of its two sides, preferably on both sides.

4. The fastening system according to claim 1, characterized in that all functional parts (2, 6, 26, 28), including any connecting means (22), are provided as layers and, at least in an initial state prior to use, are in contact with one another in a plane-parallel and full-contact manner and without any protrusions.

5. The fastening system according to claim 1, characterized in that at least some of the functional elements (2, 61 26, 28) themselves have a multilayer structure.

6. The fastening system according to claim 1, characterized in that the further functional part (6) as a whole together with the individual elements (4) is subdivided into groups (30), which, at least in a longitudinal and/or transverse direction to the extension of the film of the one functional part (2), have a predeterminable distance (34) from one another, which preferably has a gap size that is smaller than the film thickness of each of the functional parts (2, 6, 26, 28).

7. The fastening system according to claim 1, characterized in that a group member (30) of the groups (30) is formed of a single segment (32) which, in conjunction with further segments (32), forms the further functional part (6).

8. The fastening system according to claim 1, characterized in that the functional parts (2, 6, 26, 28) arranged adjacent to one another, are connected to each other without glue by means of a coating or lamination process.

9. The fastening system according to claim 1, characterized in that the respective functional part (2, 6, 26, 28) consists of a plastic material, such as polyethylene material, and in that the further functional part (6), at least to the extent of its individual elements (4), has adhesion properties of the class of poly(organo)siloxanes, preferably of a polyvinylsiloxane material.

10. The fastening system according to claim 1, characterized in that the one functional part (2) is designed bearing information and
colored
with symbols, preferably with text printed thereon
reflective
fluorescent luminous
matte or glossy
provided with AI.

11. The fastening system according to claim 1, characterized in that at least one of the functional parts (2, 6, 26, 28) is equipped with additional functions, such as being
flame retardant
recyclable
biodegradable
incinerable
magnetizable or exhibiting magnetic properties
resistant to electrostatic charge or electro-magnetically compatible (EMC)
abrasion resistant.

12. The fastening system according to claim 1, characterized in that the further functional part having the individual elements, capable of adhesion, can be produced using a forming screen in a chill-roll process.

13. The fastening system according to claim 1, characterized in that the fastening system, designed as rolled or wound material, in the unrolled or unwound state and divided into predeterminable lengths can fulfill the respective purposes.

14. A tradable merchandise item consisting of a plurality of fastening systems according to claim 1, which, combined on a carrier strip (38), as small parts (40) that can be separated from one another, after they have been detached from the carrier strip (38), are provided for the application for detachable adhesion to the third component.

15. Use of a fastening system according to claim 1, characterized in that the fastening system is used to render the information content of traffic signs of any kind ineffective and/or is used as a warning to make vehicles, such as construction vehicles, recognizable, and for which, by detaching the fastening system from such third components, the ineffective-rendering or the making-recognizable is removed without leaving any residue.
